(19) United States
(12) Patent Application Publication
(10) Pub. No.: US 2015/0178707 A1
(43) Pub. Date: Jun. 25, 2015

(54) INFORMATION PROCESSING APPARATUS

(71) Applicant: blayn inc., Tokyo (JP)

(72) Inventor: Shinichi Temmo, Tokyo (JP)

(73) Assignee: blayn inc, Tokyo (JP)

(21) Appl. No.: 14/415,785

(22) PCT Filed: Mar. 26, 2014
(86) PCT No.: PCT/JP2014/058452

§ 371 Date: Jan. 20, 2015

(30) Foreign Application Priority Data
Jul. 12, 2013 (JP) 2013-147087

(51) Int. Cl. G06Q 20/20

(52) U.S. Cl. CPC G06Q 20/209; G06Q 20/202

(57) ABSTRACT

A tablet terminal of an information processing apparatus includes: a product price input receiving unit that receives an input of a price for each settlement target product based on an operation of a user; a total amount calculating unit that adds the prices for the respective products received by the product price input receiving unit to calculate a total amount; a total amount displaying unit that displays the total amount in an amount display device as a payment; and a receipt output unit that outputs a receipt printed with settlement information, including specification information of the price for each product received by the price input receiving unit and information of the total amount, from a printer connected through the interface board. The printer, the amount display device, the interface board are stored in a housing. The housing and the tablet terminal are integrally connected to function as one cash register.

### TECHNICAL FIELD

The present invention relates to an information processing apparatus.

### BACKGROUND ART

There is known a product marketing data processing apparatus as follows. In the product marketing data processing apparatus, a tablet PC is used as a terminal for a customer to perform electronic signature (see Patent Literature 1).

### CITATION LIST

### Patent Literature

### Patent Literature 1: JP 2010-277402 A

### SUMMARY OF INVENTION

### Technical Problem

In the product marketing data processing apparatus in the related art, a CPU, a memory, and a control device including peripheral circuits such as various types of controllers are built in the apparatus. The tablet terminal as in a POS terminal disclosed in Patent Literature 1 is connected merely as an auxiliary terminal for the customer to perform the electronic signature, and all processes of operating the apparatus as a cash register such as a process of settlement and a process of printing a receipt are performed by the control device of the POS terminal. On the other hand, as the tablet terminals have been come into wide use in recent years, many tablet terminals having a high processing performance are put on the market. Therefore, in a case where various apparatuses included in the cash register are connected to the tablet terminal and an application for controlling these apparatuses is introduced in the tablet terminal even without using an expensive POS terminal, an inexpensive cash register having a simple configuration can be provided. However, the product marketing data processing apparatus in the related art does not take these configurations into consideration at all.

### Solution to Problem

According to a first aspect of the invention, an information processing apparatus includes a tablet terminal, a printer configured to print a receipt, and an amount display device configured to indicate a payment to a payer, all of which are connected through an interface board to serve as a cash register. The tablet terminal includes a product amount input receiving unit which receives an input of an amount for each settlement target product based on an operation of a user, a total amount calculating unit which adds the amounts for the respective products received by the product amount input receiving unit to calculate a total amount, a total amount displaying unit which displays the total amount calculated by the total amount calculating unit in the amount display device connected through the interface board as the payment, and a receipt output unit which outputs a receipt printed with settlement information, including specification information of the amount for each product received by the amount input receiving unit and information of the total amount calculated by the total amount calculating unit, from the printer connected through the interface board. The printer, the amount display device, the interface board are stored in a housing, and the housing and the tablet terminal are integrally connected to function as one cash register.

According to a second aspect of the invention, in the information processing apparatus of the first aspect, the interface board includes a power supply unit which supplies power to the tablet terminal, the printer, and the amount display device.

According to a third aspect of the invention, the information processing apparatus of the first or second aspect may further include a connection unit configured to connect a cash drawer for storing cash, and a cash drawer controlling unit configured to open the cash drawer connected through the connection unit based on an operation of the user.

According to a fourth aspect of the invention, in the information processing apparatus according to any of the first to third aspects, the tablet terminal may further include a settlement information transmitting unit which transmits the settlement information to an external apparatus connected through a communication line.

According to a fifth aspect of the invention, in the information processing apparatus according to any of the first to fourth aspects, the tablet terminal may further include an order information transmitting unit which transmits order information of a customer to an external apparatus connected through a communication line.

According to a sixth aspect of the invention, in the information processing apparatus according to any of the first to fifth aspects, the tablet terminal may further include a settlement completion information transmitting unit which transmits settlement completion information of a customer to an external apparatus connected through a communication line.

According to a seventh aspect of the invention, the information processing apparatus according to any of the fourth to sixth aspects may further include a communication control unit configured to be connected to a communication line through a communication module which is included in the tablet terminal, and to make communication with the external apparatus.

According to an eighth aspect of the invention, the information processing apparatus according to any of the fourth to sixth aspects may further include a communication control unit configured to be connected to a communication line through a communication module, which is connected to the interface board, and to make communication with the external apparatus.

### Advantageous Effects of Invention

According to the invention, since a tablet terminal, a printer which prints a receipt, and an amount display device which indicates a payment to a payer are connected through an interface board to serve as a cash register, it is possible to manufacture the cash register at a low cost.

### BRIEF DESCRIPTION OF DRAWINGS

FIG. 1 is a block diagram illustrating a configuration of an embodiment of an information processing apparatus 100.

FIG. 2 is a block diagram illustrating a configuration of an embodiment of an interface board 300.

FIGS. 3(A) and 3(B) are diagrams schematically illustrating a configuration in a case where the information processing apparatus 100 is integrally installed as a cash register in a store.

FIG. 4 is a block diagram illustrating a configuration of an embodiment of a tablet terminal 200.

FIG. 5 is a diagram illustrating an example of a settlement screen 5a.

FIG. 6 is a flowchart illustrating a process flow of the tablet terminal 200.

FIG. 7 is a first block diagram illustrating a configuration of an embodiment of the information processing apparatus 100 in a case where a cash drawer is connected.

FIG. 8 is a second block diagram illustrating a configuration of an embodiment of the information processing apparatus 100 in a case where the cash drawer is connected.

### DESCRIPTION OF EMBODIMENTS

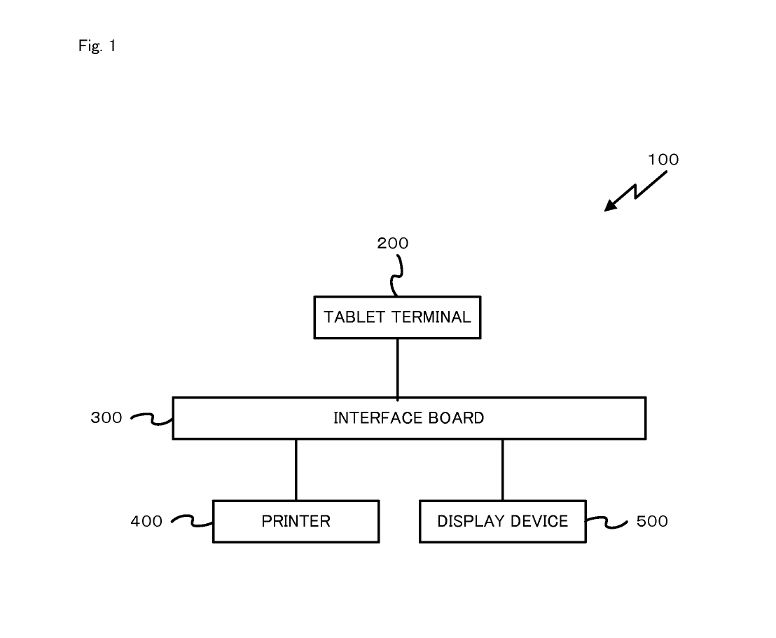

FIG. 1 is a block diagram illustrating a configuration of an embodiment of an information processing apparatus in the embodiment. An information processing apparatus 100 includes a tablet terminal 200 which is operated by a user, an interface board 300, a printer 400 which is used for printing a receipt, and a display device 500 which is used for indicating a settled amount to a payer.

In the embodiment, the information processing apparatus 100 is configured such that the tablet terminal 200, the printer 400, and the display device 500 are integrally connected through the interface board 300, and installed as one cash register in a store.

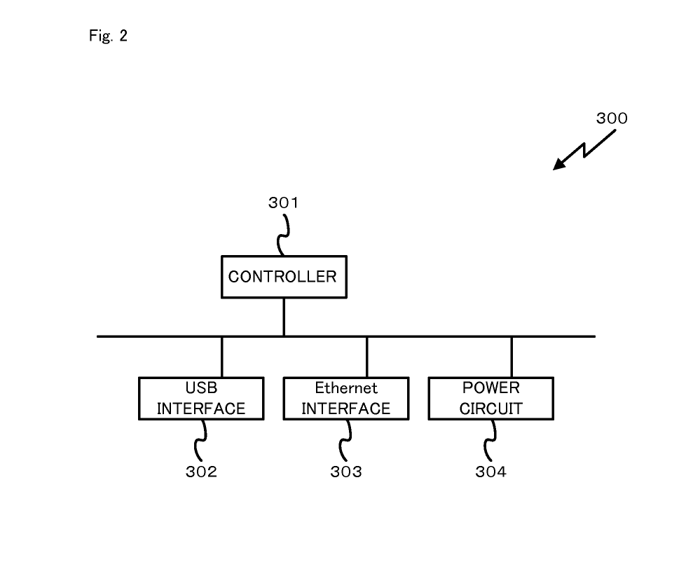

FIG. 2 is a block diagram illustrating a configuration of an embodiment of the interface board 300. The interface board 300 includes a controller 301 which controls the entire interface board 300, a USB interface 302 which is used for connecting USB-connectable devices, an Ethernet (registered trademark) interface 303 which is used for connecting an Ethernet (registered trademark) cable, a power circuit 304 which is used for supplying power to devices connected through the USB interface 302.

In the embodiment, the USB interface 302 includes a plurality of connection ports through which the tablet terminal 200, the printer 400, and the display device 500 are connected to the USB interface 302. Therefore, the tablet terminal 200, the printer 400, and the display device 500 are connected through the interface board 300.

The Ethernet (registered trademark) interface 303 is an interface for the connection with the Ethernet (registered trademark) cable in order to connect the information processing apparatus 100 to the communication line through a LAN.

The power circuit 304 is supplied with power from an AC power source through a power cable. Through the power cables (not illustrated), the power circuit 304 is connected to the tablet terminal 200, the printer 400, and the display device 500 which are connected through the USB interface 302, and supplies power to the tablet terminal 200, the printer 400, and the display device 500.

In addition, the above interface is an example for connecting the tablet terminal 200, the printer 400, and the display device 500 to the interface board 300, and the invention is not limited thereto.

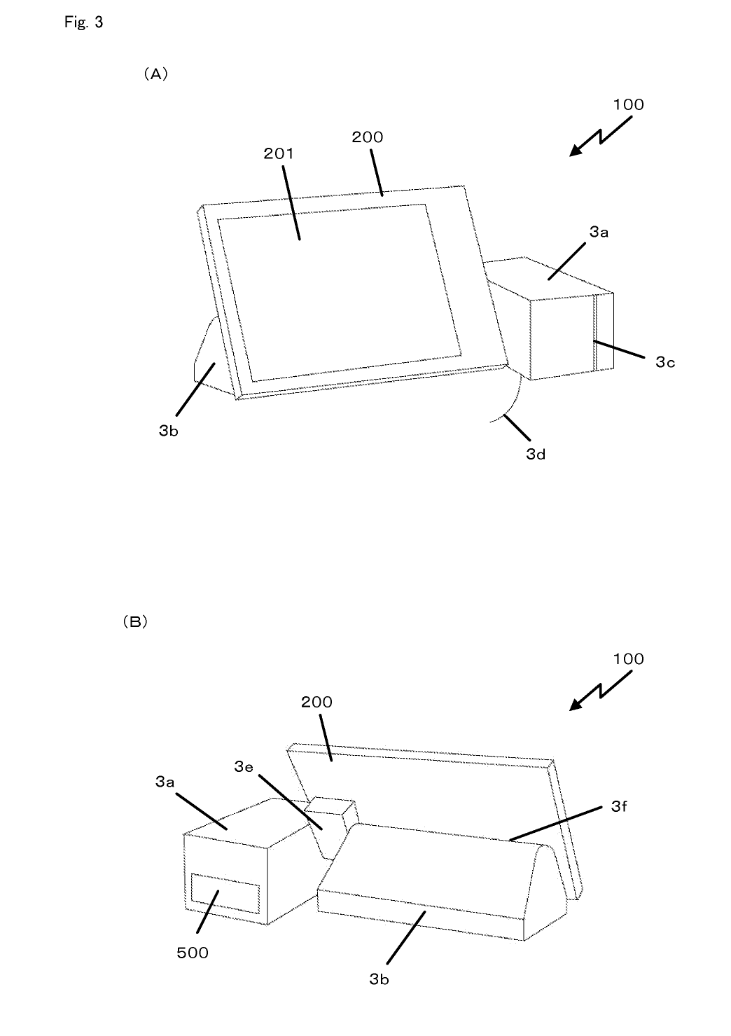

FIGS. 3(A) and 3(B) are diagrams schematically illustrating a configuration in a case where the information processing apparatus 100 is integrally installed as a cash register in a store. FIG. 3(A) is a diagram illustrating a configuration of the information processing apparatus 100 in front view, and FIG. 3(B) is a diagram illustrating a configuration of the information processing apparatus 100 in back view. In addition, herein, in a case where the information processing apparatus 100 is installed in the store as the cash register, a side facing a clerk (the user) for the operation is called a front side, and a side facing a customer for settling up amounts is called a back side.

FIG. 3(A) illustrates a housing 3a in which the printer 400 and the display device 500 are stored, a housing 3b in which the interface board 300 is stored, and the tablet terminal 200. Further, FIG. 3(B) illustrates a connection member 3e which is used for connecting the housing 3a, the housing 3b, and the tablet terminal 200 besides the housing 3a, the housing 3b, the tablet terminal 200. Cables for connecting the housing 3a and the housing 3b and cables for connecting the housing 3b and the tablet terminal 200 are wired through the inside of the connection member 3e.

As illustrated in FIG. 3(A), the housing 3a is provided with a receipt discharge port 3c in a slit shape to discharge a receipt to the front side. The receipt printed by the printer 400 which is stored in the housing 3a is output from the receipt discharge port 3c. Therefore, the user standing in the front side can hand over the discharged receipt to the customer. Further, as illustrated in FIG. 3(B), a price display portion of the display device 500 which is stored in the housing 3a is visibly provided to the outside through an opening portion provided on the back side. With this configuration, the payer can check a payment which is displayed in the display device 500 at the time of settling up the amount.

As illustrated in FIG. 3(A), a power cable 3d is led out through a cable hole provided in the housing 3a to the outside to supply power to the power circuit 304 of the interface board 300.

Further, as illustrated in FIGS. 3(A) and 3(B), the housing 3b functions as a pedestal to erect the tablet terminal 200 in the vertical direction with respect to an abutting face of the information processing apparatus 100. Then, a slope is provided in the housing 3b to fix the tablet terminal 200 to a face abutting on the tablet terminal 200 at an angle with respect to the grounding face of the information processing apparatus 100 so that the user easily makes an operation. In the example illustrated in FIGS. 3(A) and 3(B), the touch panel 200 is set at an angle obliquely rising upward on an assumption that the user makes an operation at an angle obliquely looking down on a touch panel 200 from the upper position.

In addition, the angle of the touch panel 200 may be fixed, and may be configured to be changeable by the user. In this case, for example, in FIG. 3(B), a rotation mechanism such as a rotation shaft may be provided to make the tablet terminal 200 rotate along the side of the housing 3b denoted by Symbol 3f. Therefore, the user can change the angle according to a positional relation between the user and the information processing apparatus 100 in order to easily operate the tablet terminal 200.

In this way, the information processing apparatus 100 is desirably made in an appropriate shape in consideration of the installation as the cash register in the store, but the shape is not limited to the example illustrated in FIGS. 3(A) and 3(B).

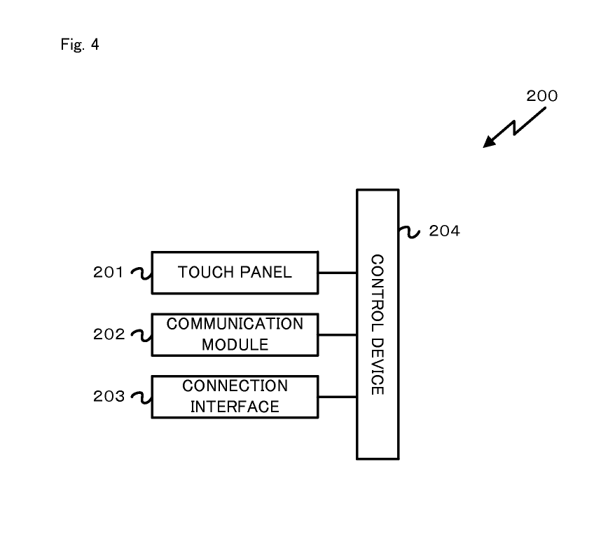

FIG. 4 is a block diagram illustrating a configuration of an embodiment of the tablet terminal 200 in the embodiment. In the embodiment, the tablet terminal 200 is installed with an application to control the printer 400 and the display device 500 which are connected through the interface board 300 so as to operate the information processing apparatus 100 as the cash register. In the embodiment, the application of making the information processing apparatus 100 operated as the cash register will be referred to as a cash register application.

A program of the cash register application is assumed to be publicly open on a server connected through the Internet, and the user can download and install the program to the tablet terminal 200 in advance. Alternatively, the program of the cash register application may be provided through a recording medium such as a CD-ROM or a DVD-ROM containing the program recorded therein.

The tablet terminal 200 includes a touch panel 201, a communication module 202, a connection IF 203, and a control device 204.

The touch panel 201 is an electronic component formed by combining a display device such as a liquid crystal panel and a position input device such as a touch pad, and serves as an input device which can operate the component by pushing display items on the screen. For example, the user of the tablet terminal 200 can operate the tablet terminal 200 by touching or sliding the display items such as a button or a menu displayed on the liquid display panel using a finger or a touch pen. The touch panel 201 detects a touching or a sliding performed by the user, and outputs the detected signal to the control device 204.

As the communication module 202, there is employed a module to be connected to the Internet in a wireless manner through a LAN or a mobile telephone network. The program of the cash register application is acquired by being downloaded from an external server through the communication module 202.

The connection IF 203 is an interface which is used for connecting the tablet terminal 200 to the interface board 300. In the embodiment, for example, the USB interface is used as described above.

The control device 204 includes a CPU, a memory, and peripheral circuits, and controls the entire tablet terminal 200. In addition, examples of the memory included in the control device 204 include a volatile memory such as an SDRAM and a non-volatile memory such a flash memory. The volatile memory is used as a work memory in which the CPU develops the program during run time, or a buffer memory in which data is temporarily recorded. Further, program data of firmware for operating the tablet terminal 200 and program data of software for operating various applications are recorded in the non-volatile memory. In the embodiment, the program of the above-mentioned cash register application is recorded in the non-volatile memory.

The user of the information processing apparatus 100 touches an icon for activating the cash register application displayed on the touch panel 201 of the tablet terminal 200 to activate the cash register application, so that the information processing apparatus 100 can be used as the cash register. Hereinafter, in a case where the information processing apparatus 100 is used as the cash register, the content of processes performed by the tablet terminal 200 will be described.

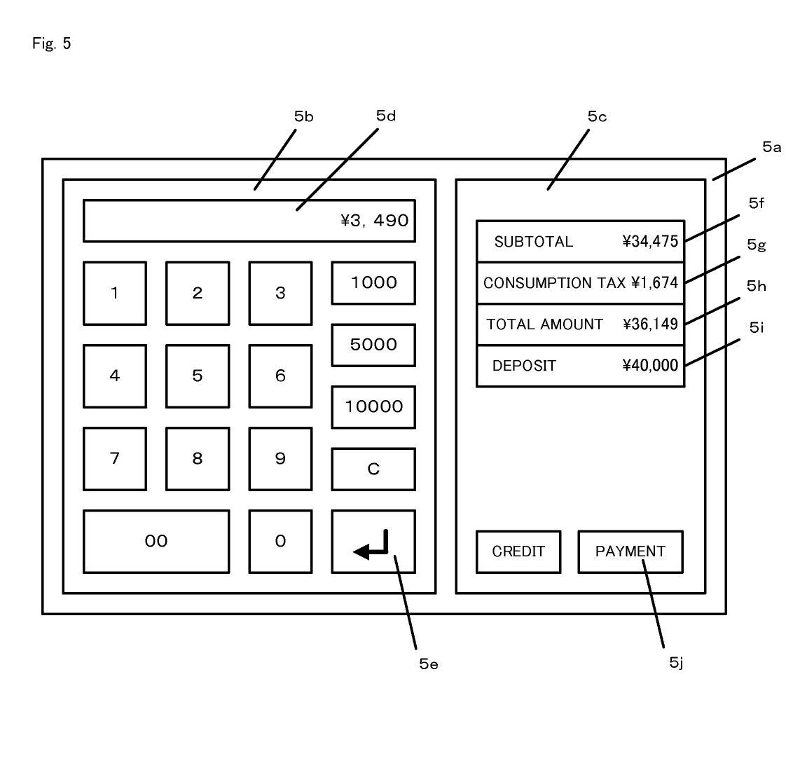

In a case where a customer settles up purchases, the user settles up the payment using a settlement function of the cash register application. When a user's operation to instruct the settlement to start is detected on the touch panel 201, the control device 204 displays an amount settlement screen 5a illustrated in FIG. 5 on the touch panel 201.

The amount settlement screen 5a includes a calculator display area 5b and a settlement content display area 5c, and the user inputs the prices of products onto a user interface imitated after a calculator displayed in the calculator display area 5b. Buttons disposed in the calculator display area 5b have the same functions as those included in a typical calculator, and thus a detailed operation method is not described. The user can input the price of the product by touching numeric buttons disposed in the calculator display area 5b, and can confirm the input price by touching an enter button 5e.

The control device 204 displays the price which is input by the user's touching on the numeric buttons in a price display portion 5d. Further, in a case where the user touches the enter button 5e to confirm the price, the control device 204 records the confirmed price in a memory as a price specification of the products. Then, the control device 204 adds the confirmed input price to a subtotal amount displayed in a subtotal column 5f of the settlement content display area 5c, calculates a consumption tax amount on the subtotal amount based on a predetermined consumption tax, and displays the calculated consumption tax amount in a consumption tax display column 5g. Then, a total amount obtained by adding the subtotal amount displayed in the subtotal column 5f and the consumption tax amount displayed in the consumption tax display column 5g is displayed in a total amount column 5h. Further, the control device 204 transmits information indicating the total amount to the display device 500 connected through the interface board 300 to display the total amount.

After the prices of all the products are completely input, for example, the user confirms the total amount by touching the enter button 5e once more, informs the payer of the total amount displayed in the display device 500, and receives the payment from the payer. Then, the user enters the amount received from the payer by touching the buttons disposed in the calculator display area 5b, and touches the enter button 5e.

In a case where the user confirms the amount received by touching the enter button 5e, the control device 204 displays the input receipt amount in a deposit column 5i of the settlement content display area 5c.

Then, when the user's touching on a payment button 5j is detected, the control device 204 outputs settlement information including specification information of the prices of the respective products recorded in the memory and information of the total amount to the printer 400 connected through the interface board 300 to output a receipt on which the settlement information is printed in a predetermined format. Therefore, the user can hand over the receipt output from the printer 400 to the payer.

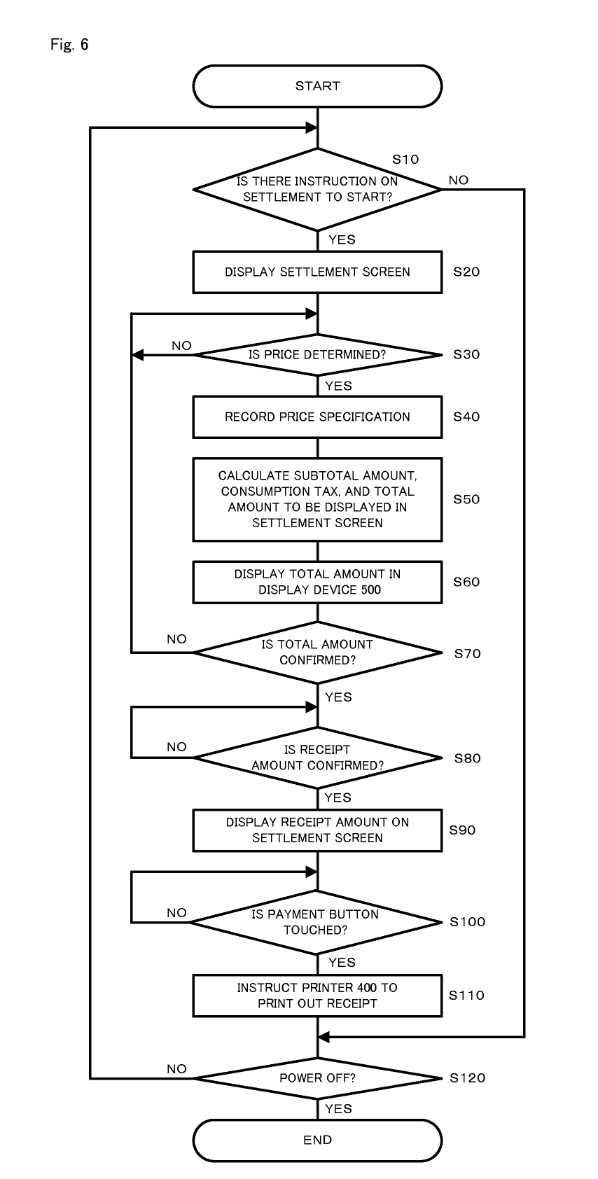

FIG. 6 is a flowchart illustrating a process flow of the tablet terminal 200 in the embodiment. The process illustrated in FIG. 6 is performed by the control device 204 by executing a program activated when the user instructs the execution of the cash register application described above.

In Step S10, the control device 204 determines whether the user instructs the settlement to start on the touch panel 201. In a case where it is determined as NO in Step S10, the procedure proceeds to Step S120 to be described below. In contrast, in a case where it is determined as YES in Step S10, the procedure proceeds to Step S20.

In Step S20, the control device 204 displays the amount settlement screen 5a illustrated in FIG. 5 on the touch panel 201. Then, the procedure proceeds to Step S30.

In Step S30, as described above, the control device 204 determines whether the user inputs the price of the product using the numeric buttons disposed in the calculator display area 5b and confirms the input price by touching the enter button 5e. In a case where it is determined as YES in Step S30, the procedure proceeds to Step S40.

In Step S40, the control device 204 records the confirmed price as a price specification of each product in the memory. Then, the procedure proceeds to Step S50.

In Step S50, as described above, the control device 204 calculates the subtotal amount, the consumption tax amount, and the total amount, and displays the calculated amounts in the subtotal column 5f, the consumption tax display column 5g, the total amount column 5h of the settlement content display area 5c, respectively. Then, the procedure proceeds to Step S60.

In Step S60, the control device 204 displays the total amount calculated in Step S50 in the display device 500 connected through the interface board 300. Then, the procedure proceeds to Step S70.

In Step S70, the control device 204 determines whether the above-mentioned total amount is confirmed as the payment, base on, for example, the user's performing of an operation for confirming the payment by touching the enter button 5e once more. In a case where it is determined as NO in Step S70, the procedure returns to Step S30. In contrast, it is determined as YES in Step S70, the procedure proceeds to Step S80.

In Step S80, the control device 204 determines whether the user inputs the amount paid by the payer and confirms the receipt amount by touching the enter button 5e. In a case where it is determined as YES in Step S80, the procedure proceeds to Step S90.

In Step S90, the control device 204 displays the confirmed receipt amount in the deposit column 5i of the settlement content display area 5c. Then, the procedure proceeds to Step S100.

In Step S100, the control device 204 determines whether the user touches the payment button 5j. In a case where it is determined as YES in Step S100, the procedure proceeds to Step S110.

In Step S110, the control device 204 outputs settlement information including specification information of the prices of the respective products recorded in the memory and information of the total amount to the printer 400 connected through the interface board 300, and instructs the printer to output a receipt on which the settlement information is printed in a predetermined format. Then, the procedure proceeds to Step S120.

In Step S120, the control device 204 determines whether the user makes an instruction on the information processing apparatus 100 to be powered off. In a case where it is determined as NO in Step S120, the procedure returns to Step S10. In contrast, in a case where it is determined as YES in Step S120, the process is ended.

According to the embodiment described above, the following operational advantages can be obtained. (1) The information processing apparatus 100 includes the tablet terminal 200, the printer 400 which prints a receipt, and the display device 500 which indicates a payment to the payer, all of which are connected through the interface board 300. In the tablet terminal 200, the control device 204 receives an input of the prices of the respective settlement target products, adds the received prices of the products to calculate a total amount, and displays the calculated total amount in the display device 500 connected through the interface board 300 based on the user's operation. Further, on the basis of the user's operation, the control device 204 causes the printer 400 connected through the interface board 300 to output a receipt on which settlement information including specification information of the prices of the respective products and information of the total amount. Therefore, it is possible to provide the information processing apparatus 100 serving as a cash register by a simple configuration in which the tablet terminal 200, the printer 400, and the display device 500 are connected through the interface board 300, so that the cash register can be supplied at a low cost.

(2) The interface board 300 is configured to have a power circuit built therein to supply power to the tablet terminal 200, the printer 400, and the display device 500. Therefore, there is no need to plug the tablet terminal 200, the interface board 300, the printer 400, and the display device 500 in power sockets. When only the interface board 300 is plugged in the power socket, the power can be supplied to the tablet terminal 200, the printer 400, and the display device 500 from the interface board 300. Accordingly, since only the power cable 3d connected to the interface board 300 is sufficient for the power cable to be plugged in the power socket at the time of installation, a wiring work performed at the time of installation can be simplified and the wiring can be made neatly.

Modification

In addition, the information processing apparatus 100 described above can be modified as follows. (1) In the embodiment described above, the description has been made about an example in which the user inputs the price of the product on the user interface imitated after a calculator displayed in the calculator display area 5b of the amount settlement screen 5a. However, the method of inputting the price of the product is not limited to the above-mentioned method. For example, the price of the product can be input as described below.

The user previously registers information on products which are handled in a store and prices thereof in the tablet terminal 200. The control device 204 may be configured to display a list of the registered products on the amount settlement screen at the time of settling up the amount, accept selecting of a product purchased by the customer from the user, and specify the price of the selected product as the price of the product purchased by the customer.

Alternatively, in the case of a business such as a restaurant where a payment is usually performed in units of tables, order data received from a customer is managed for each table. Thus, the control device 204 may be configured to accept a selection of a settlement target table on the touch panel 201 at the time of settling up the amount, and specify the price of the product ordered by the customer based on the order data of the selected table.

(2) In the embodiment described above, the description has been made about an example of conducting communication with an external server through the Ethernet (registered trademark) cable connected to the Ethernet (registered trademark) interface 303. In this case, the control device 204 of the tablet terminal 200 may be configured to be connected to the external server through a communication line and transmit the above-mentioned settlement information, so that a history of past settlement information is recorded in the external server. Therefore, the history of the settlement information can be managed in the external server. In addition, the control device 204 may conduct communication with the external server through the communication module 202.

Further, the control device 204 may transmit information other than the settlement information to the external server. For example, the control device 204 may be configured to record order information including a product specification ordered by the customer based on the input operation from the user or based on data received from an order-accepting terminal apparatus which is wirelessly connected. Then, the order information of the customer is transmitted to the external server through the Ethernet (registered trademark) interface 303 or the communication module 202 based on the operation of the user or at a predetermined timing point. Therefore, the history of the order information of the customer can be managed by the external server.

Further, when the user's touching on the payment button 5j is detected, the control device 204 determines whether the user completes the settlement, and records settlement completion information indicating whether the customer's settlement is completed in the memory. Then, the settlement completion information of the customer may be transmitted to the external server through the Ethernet (registered trademark) interface 303 or the communication module 202 based on the operation from the user or at a predetermined timing point. Therefore, the history of settlement information of the customer can be managed by the external server.

(3) In the embodiment described above, the description has been made about an example in which the information processing apparatus 100 is configured to integrate the tablet terminal 200, the interface board 300, the printer 400, and the display device 500 and is provided as the cash register. In this case, the information processing apparatus 100 may be connected to a cash drawer for storing cash. For example, the cash drawer for storing cash is optionally provided by a provider of the information processing apparatus 100, and at a store introducing the cash drawer, the information processing apparatus 100 can be used as the cash register with the cash drawer mounted thereon by configuring the cash drawer to be connected to the information processing apparatus 100.

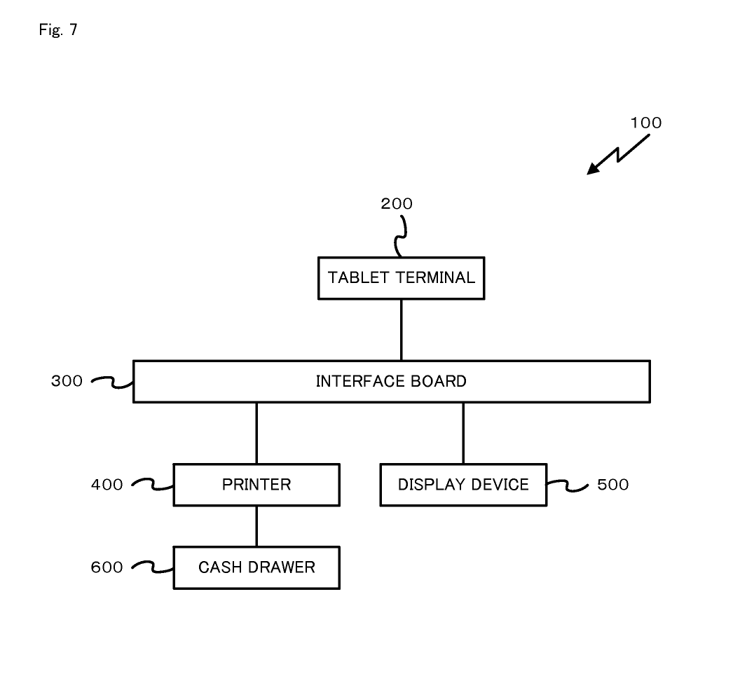

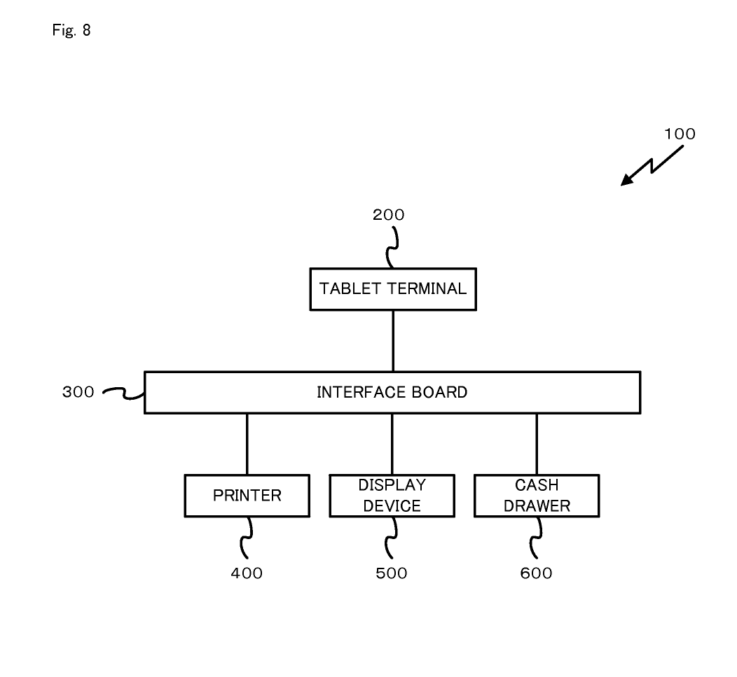

In this case, a method of connecting the information processing apparatus 100 and the cash drawer, for example, may be performed as illustrated in FIG. 7 or 8. FIG. 7 illustrates an example of connecting a cash drawer 600 to a connection interface provided in the printer 400. FIG. 8 illustrates an example in which a connector for the connection of the interface board 300 is provided and the cash drawer 600 is connected to the interface board 300.

Further, in a case where the cash drawer 600 is connected to the information processing apparatus 100, when the user's touching on the payment button 5j in the amount settlement screen 5a described above using FIG. 5 is detected, the control device 204 of the tablet terminal 200 prints the receipt from the printer 400 as described above and transmits a signal for making the drawer opened to store cash to the cash drawer 600 connected through the printer 400 or the interface board 300 to make the cash drawer 600 opened. Therefore, the user can store the cash received from the payer into the cash drawer 600, and in a case where a change is needed, the user can take out the change from the cash drawer 600 and hand the change over to the payer.

(4) In the embodiment described above, the description has been made about an example in which the user uses the information processing apparatus 100 as the cash register by touching an icon for activating the cash register application displayed on the touch panel 201 of the tablet terminal 200 so as to activate the cash register application, and the process illustrated in FIG. 6 is executed as a program activated by the control device 204 when the user instructs the execution of the cash register application. However, the process illustrated in FIG. 6 may be executed as a program activated by the control device 204 when the user turns on the power source of the information processing apparatus 100. Therefore, the user can uses the information processing apparatus 100 as the cash register only by turning on the power source of the information processing apparatus 100.

In addition, the invention is not limited to the configuration described above as long as the functional features of the invention are not damaged. Further, the invention may be configured by combination of the above embodiment and a plurality of modifications.

This application is based upon and claims the benefit of priority from the prior Japanese Patent Application No. 2013-147087, filed on Jul. 12, 2013, the entire contents of which are incorporated herein by reference.

### REFERENCE SIGNS LIST

100 Information processing apparatus
200 Tablet terminal
201 Touch panel
202 Communication module
203 Connection IF
204 Control device
300 Interface board
301 Controller
302 USB interface
303 Ethernet (registered trademark) interface
304 Power circuit
400 Printer
500 Display device
600 Cash drawer

1. An information processing apparatus comprising:
a tablet terminal;
a printer configured to print a receipt; and
an amount display device configured to indicate a payment to a payer,
wherein the tablet terminal, the printer, and the amount display device are connected through an interface board to serve as a cash register,
wherein the tablet terminal includes
a product price input receiving unit which receives an input of a price for each settlement target product based on an operation of a user,
a total amount calculating unit which adds the prices for the respective products received by the product price input receiving unit to calculate a total amount,
a total amount displaying unit which displays the total amount calculated by the total amount calculating unit in the amount display device connected through the interface board as the payment, and
a receipt output unit which outputs a receipt printed with settlement information, including specification information of the price for each product received by the price input receiving unit and information of the total amount calculated by the total amount calculating unit, from the printer connected through the interface board,
wherein the printer, the amount display device, the interface board are stored in a housing, and
wherein the housing and the tablet terminal are integrally connected to function as one cash register.

2. The information processing apparatus according to claim 1, wherein
the interface board includes a power supply unit which supplies power to the tablet terminal, the printer, and the amount display device.

3. The information processing apparatus according to claim 1, further comprising:
a connection unit configured to connect a cash drawer for storing cash; and
a cash drawer controlling unit configured to open the cash drawer connected through the connection unit based on an operation of the user.

4. The information processing apparatus according to claim 1, wherein
the tablet terminal further includes a settlement information transmitting unit which transmits the settlement information to an external apparatus connected through a communication line.

5. The information processing apparatus according to claim 1, wherein
the tablet terminal further includes an order information transmitting unit which transmits order information of a customer to an external apparatus connected through a communication line.

6. The information processing apparatus according to 1, wherein
the tablet terminal further includes a settlement completion information transmitting unit which transmits settlement completion information of a customer to an external apparatus connected through a communication line.

7. The information processing apparatus according to claim 4, further comprising;
a communication control unit configured to be connected to a communication line through a communication module which is included in the tablet terminal, and to make communication with the external apparatus.

8. The information processing apparatus according to claim 4, further comprising;
a communication control unit configured to be connected to a communication line through a communication module, which is connected to the interface board, and to make communication with the external apparatus.

9. The information processing apparatus according to claim 5, further comprising:
a communication control unit configured to be connected to a communication line through a communication module which is included in the tablet terminal, and to make communication with the external apparatus.

10. The information processing apparatus according to claim 5, further comprising:
a communication control unit configured to be connected to a communication line through a communication module, which is connected to the interface board, and to make communication with the external apparatus.

11. The information processing apparatus according to claim 6, further comprising:
a communication control unit configured to be connected to a communication line through a communication module which is included in the tablet terminal, and to make communication with the external apparatus.

12. The information processing apparatus according to claim 6, further comprising:
a communication control unit configured to be connected to a communication line through a communication module, which is connected to the interface board, and to make communication with the external apparatus.
